(19) United States
(12) Patent Application Publication
(10) Pub. No.: US 2014/0278740 A1
(43) Pub. Date: Sep. 18, 2014

(54) SYSTEM AND METHOD FOR ANALYZING PAYMENT CARD TRANSACTION DATA

(71) Applicant: MASTERCARD INTERNATIONAL INCORPORATED, (US)

(72) Inventor: Peter Groarke, Dublin (IE)

(73) Assignee: MASTERCARD INTERNATIONAL INCORPORATED, Purchase, NY (US)

(21) Appl. No.: 13/827,711

(22) Filed: Mar. 14, 2013

(51) Int. Cl. G06Q 30/02

(52) U.S. Cl. CPC G06Q 30/0201
USPC 705/7.29

(57) ABSTRACT

A method for analyzing payment card transaction data that includes storing transaction information, the transaction information including, for each transaction: an identifier of a physical terminal at which the transaction was conducted, an indicator of a time at which the transaction was conducted and an indicator of a cardholder account number to which the transaction is charged. The transaction information is analyzed to compute from the transaction information an indicator of a presumed acquaintance between a first cardholder with a first account number and any further cardholder with another account number in response to the cardholders conducting respective transactions within a period of time at a given terminal a plurality of times within a given interval with the interval being greater than the period of time.

### BACKGROUND OF THE DISCLOSURE

1. Field of the Disclosure

The present disclosure relates to payment card systems. More particularly, it relates to a system and a method for analyzing transactions conducted using payment card systems.

2. Description of the Related Art

MasterCard operates what is known as a “four-party” payment card system. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer). In a typical four-party payment card transaction, the merchant pays a “merchant discount fee” (i.e., a merchant service charge) to the acquirer in recognition of the services provided by the acquirer in facilitating payment card acceptance by the merchant. However, a substantial portion of the benefits that the merchant receives through card acceptance comes from the value of the network and services performed by the card issuer. For example, the card issuers underwrites and extends credit to the cardholder of a credit card, which enables the sale, and the card issuer assumes the risk of nonpayment by the cardholder, which enables the merchant to get paid for the transaction even if card issuer does not. To compensate the card issuer for providing such benefits to the acquirer's merchant customer, the acquirer pays an “interchange fee” to the card issuer in connection with a payment card transaction. The interchange fee helps to partially reimburse the card issuer for the many activities it performs and costs it incurs that enable the acquirer to provide significant benefits and value to its merchant customers. Interchange fees are only one of the many cost components of the merchant discount fees that are established by acquirers and paid by merchants in exchange for card acceptance services provided by acquirers to merchants.

It is of course desirable for all parties in such systems to leverage as much value as they can from the payment system. Thus, for example, customers can be incentivized to take up and use a card with a view to availing of offers provided by a card issuer such as Air Miles, Nectar Points™ or even Cash Back. An increased customer base conducting larger numbers of transactions therefore benefits all parties.

Thus, the present disclosure overcomes the shortcomings of the prior art, and uses information available within a payment card system to add further value to parties involved in the system.

### SUMMARY OF THE DISCLOSURE

The present disclosure provides a system and a method for analyzing transaction data within a payment card company system.

The present method can be used in a four party payment card processing system.

The present disclosure further provides a computer readable non-transitory storage medium storing instructions of a computer program, that when executed by a computer system, result in performance of steps of the method described for analyzing transaction data within payment systems.

### BRIEF DESCRIPTION OF THE DRAWINGS

Embodiments of the present invention will now be described, by way of example only, with reference to the accompanying drawings, in which:

FIG. 1 is a diagram of a four party payment card system.

FIG. 2 is a block diagram of a portion of a payment card system modified in accordance with one aspect of the present disclosure.

A component or a feature that is common to more than one drawing is indicated with the same reference number in each of the drawings.

### DESCRIPTION OF THE PREFERRED EMBODIMENT

Referring to the drawings and, in particular, FIG. 1, there is shown a four party system 10. The cardholder 20 submits the credit card to the merchant 30. The merchant's point of sale device 80 (80A, 80B, 80C . . . 80N, shown in FIG. 2, communicates 32 with his acquiring bank or acquirer 40, which acts as a payment processor. The acquirer 40, at 42, initiates the transaction on the payment card or payment card company network 50. The payment card network 50 routes at 62 the transaction to the issuing bank or card issuer 60, which is identified using information in the transaction message, more fully described below. The card issuer 60 approves or denies an authorization request. At 42, the card issuer 60, then routes, via the payment card network 50, an authorization response back to the acquirer 40. The acquirer 40 sends approval to the POS device of the merchant 30. Seconds later, the cardholder completes the purchase and receives a receipt.

The account of the merchant 30 is credited at 70 by the acquirer 40. The card issuer 60 pays the acquirer at 72. Eventually, at 74, the cardholder 20 pays the card issuer 60.

Referring to FIG. 2, each merchant has on their premises at least one point of sale (POS) device 80 (80A, 80B, 80C . . . 80N), such as a card swiping machine or some other type of device well known in the art for initiating customer transactions. These point of sale devices generally also have keyboard data entry pads for instances when it becomes necessary to enter data manually, such as when a card's magnetic coding becomes difficult to read, or when the customer provides card data by telephone. Point of sale devices 80 (80A, 80B, . . . 80N) are connected by a suitable network to a transaction concentrator (or aggregator) 90, for a given geographic area, which concentrates the transaction information. Each concentrator 90 has associated with it a transaction database 100 that stores information concerning the transaction. Transaction database 100 may acquire information from more than one concentrator 90, and thus may include data from a wide geographic area. Information from the concentrator 90 also is routed to a respective acquiring bank 110 that, in turn, routes the information so that transactions are properly completed using the system illustrated in FIG. 1.

While it is advantageous to maintain a local database including transactions in a given geographic area, there is no such limitation on various embodiments of the present disclosure. The time to search this more extensive database, and provide a response to a user, may be slightly greater, but the user will obtain the same useful information.

Information that is exchanged across the payment card company network for each credit or debit card financial transaction message includes the following characteristics: customer PAN (primary account number) comprising a combination of issuer/account number and check digit uniquely identifying a cardholder's account; acquirer identifier/card accepter identifier (the combination of which uniquely defines the merchant); merchant address (i.e., full address and or GPS data); merchant category code (also known as card acceptor business code), that is an indication of the type of business the merchant is involved in (for example, a gas station); local transaction date and time; cardholder base currency (i.e., U.S. Dollars, Euros, Yen, etc.); POS (or ATM) terminal identifier; product specific data such as SKU line item data; and cost of the transaction.

It will be seen that within the payment card company network, there is a limited amount of information available—for example, a cardholder cannot be identified by a payment card company based on the above transaction information. Nonetheless, embodiments of the present disclosure employ this transaction information to further incentivize the use of credit cards.

The present disclosure is based on the observation that while it is common for any two individuals to perform a card transaction at a physical terminal, i.e. a terminal at which a user with their card is present, within a given period of time (Pt), if two individuals perform more than one such card transaction at a given physical terminal within a given interval (I), it is a strong indicator that such individuals are acquainted with one another. This knowledge can be used to build a set of indicators of PANs associated with other PANs and this information can be used in a number of ways.

In a first embodiment, the service is implemented by the payment card company or by a service provider on behalf of the payment card company—in each case, they are referred to as the service provider. A service provider website 170 including a processor 180 and a memory 185 is provided and this allows customers who wish to subscribe to the service to register. In registering, the customer provides both their PAN and their personal details which would otherwise not be available within the payment card company network and within the database 100. By registering, the customer indicates to the service provider that they are prepared to have acquaintance information built up by the service provider around transactions including their PAN employed by the service provider.

Depending on data protection requirements; acquaintance information may be limited to using PAN information only for users who are subscribed to or are participating in the service or for other cases allowed by law, such as fighting fraud or theft. Otherwise, information built from all transactions may be suitably anonymized when used by the service provider.

In one implementation, the service provider, either periodically by batch processing transaction information or in real-time, compares transactions for a given PAN with transactions made at the same physical terminal within a given period of time (Pt). Alternatively, the database might be searched by terminal identifier and to determine PAN couplets involved in transactions at a given terminal within the period Pt. This period of time Pt can be fixed or it can be made dependent on the terminal identifier. Thus for terminals where it is known that transaction activity is at a high frequency and that customers might not be in proximity of the terminal for very long, Pt can be relatively shorter, whereas for low transaction frequency terminals and where it is known that customers might be in proximity of the terminal for longer, Pt can be longer.

It will also be appreciated that as well as being a merchant POS terminal, the physical terminal could also be an Automatic Teller Machine (ATM). Here customers are least likely to remain in proximity to the terminal and in this case, Pt might be shortest. Nonetheless, it will be appreciated that the invention is based on physical proximity and as such, only transaction information from physical terminals where a user is physically present at transaction time is used. Thus, transaction information from card-not-present, e-commerce Internet merchants is not employed.

In general Pt is significantly shorter than the larger interval I and in one implementation Pt varies about 15 minutes and might be up to 1 hour or so, whereas I is at least one day and typically of the order of between 1 month and 1 year. In any case, once the service provider identifies two PANs recording a transaction within a period Pt with an occurrence greater or equal to a threshold T within the interval I, the owners of the PANs are assumed to be acquainted with one another. To be clear, the instances of “coupled transactions” need not occur at the same terminal, but could occur at any terminal. Nonetheless, the physical proximity of terminals at which such coupled transactions between possibly acquainted cardholders could be taken into account when making a determination of presumed acquaintance—thus for example, two coupled transactions at relatively remote terminals might be more strongly indicative of acquaintance than two coupled transactions at the same or proximate terminals.

The threshold T is greater than 1, but it need not be very high for the observation underlying the invention to be correct, and it is believed that T need not be greater than 5 in a given interval I for the observation to be correct.

An indicator of the number of acquaintances associated with each PAN can be maintained by the service provider; or indeed where permitted, or if desired, an indicator of the PAN owner's presumed network of participating acquaintances can be maintained.

This information can be used by the service provider for any number of permitted purposes. For example, participants can receive rewards based on their number of presumed acquaintances and can move upwards within a tiered rewards system according to their level of presumed acquaintances. The rewards can be provided directly by the service provider or they can be provided in conjunction with merchants who wish to communicate with credit card customers. It will be appreciated that communicating with such customers who in general spend often with a credit/debit card and who are also connected to other cardholders who spend, can be extremely valuable to given merchants.

At the same time, customers who are aware of the rewards are likely to recommend to their actual acquaintances that they employ a card issued by the payment card company providing the service and also that they use the card as often as possible, not alone when they are in the presence of actual acquaintances, both others they recognize who might make transactions at the same terminal.

In another implementation, the service is provided by or on behalf of a card issuer. Some card issuers seek to reward customers for frequently using their payment card with incentives. Thus, some card issuers issue affinity cards with the affinity partner providing rewards to a customer based on their card usage. In this case, a card issuer would be provided with acquaintance information by the payment card company for its participating card holders. Therefore, the payment card company indicates to the card issuer either the number of presumed acquaintances, it has determined for a participating PAN; or indeed it might provide PAN details for all presumed acquaintances of any given PAN to whom the card issuer has provided cards.

Again, the card issuer can reward the cardholder according to their number of presumed acquaintances. This provides an incentive not alone for the customer to acquire their card from a particular card issuer, but also to use a card from that issuer for a particular payment card company who provide the information to the card issuer.

It will be seen that transaction records stored in transaction database 100 contain information that is highly confidential and must be maintained as such to prevent fraud and identity theft. The transaction records stored in transaction database 100 can be sent through a filter 120 that removes information not required to implement the present invention, but retains or transforms transaction records including terminal identifier, PAN identification and the times of occurrence for each transaction; preferably in real time, so that they can be used. The filtered and/or transformed data is stored in a transaction database 130, which may be accessed in preference to the database 100 as described above. The data of the database may be stored in any type of memory, including a hard drive, a flash memory, on a CD, in a RAM, or any other suitable memory.

Thus, it is clear that the embodiments of the present disclosure described herein can benefit payment card companies, merchants, card issuers, and/or customers.

It will be understood that while the present disclosure has been described primarily with respect to the four party credit card system, it can be applied to other kinds of payment card systems, such as debit card charging systems.

It will also be seen that the observation of presumed acquaintance could be of use to security agencies investigating a given cardholder. In response to a request, a payment card company could provide an appropriately authorized agency with a set of PANs for presumed acquaintances of a given PAN. As any given PAN includes an identifier of the card issuer, the agency would then be able to request the issuer to identify the individual who might be associated with the original PAN and to use this information as part of an investigation.

It will be understood that the present disclosure may be embodied in a computer readable non-transitory storage medium storing instructions of a computer program which when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for analyzing payment card transaction data, comprising:
an electronic storage device arranged to store transaction information, said transaction information including for each transaction: an identifier of a physical terminal at which said transaction was conducted, an indicator of a time at which said transaction was conducted, and an indicator of a cardholder account number to which said transaction is charged; and
a processor arranged to analyze the transaction information, and for computing from the transaction information an indicator of a presumed acquaintance between a first cardholder with a first account number and a second cardholder with another account number in response to said first and second cardholders conducting respective transactions within a period of time at a given terminal a plurality of times within a given interval, said interval being greater than said period of time.

2. The system according to claim 1, wherein said period of time is less than 1 day.

3. The system according to claim 1, wherein said period of time is less than 1 hour.

4. The system according to claim 1, wherein said interval is greater than 1 day,

5. The system according to claim 1, wherein said interval is greater than 1 month.

6. The system according to claim 1, wherein said plurality of times is greater than 1 and less than or equal to 5.

7. The system according to claim 6, wherein said plurality is either 2 or 3.

8. The system according to claim 1 wherein said period of time is variable and dependent on the terminal identity.

9. The system according to claim 8, wherein said period of time is inversely proportional to the frequency of transactions at a terminal.

10. The system according to claim 1, wherein said physical terminal includes one of a merchant Point of Sale (POS) terminal or an Automatic Teller Machine (ATM).

11. The system according to claim 1, wherein said database of transaction information is either: a payment card company transaction database; or extracted from a payment card company transaction database.

12. The system according to claim 1, wherein said indicator of a presumed acquaintance comprises a count of the number of further cardholders with whom a first cardholder is presumed to have an acquaintance.

13. The system according to claim 1, wherein said indicator of a presumed acquaintance comprises a set of account numbers for further cardholders with whom a first cardholder is presumed to have an acquaintance.

14. The system according to claim 11, wherein said database of transaction information only includes transaction information for cardholders who have agreed to participate with said system.

15. The system according to claim 1, further comprising a web server operable to acquire from participating cardholders, a cardholder identity corresponding to a cardholder account number.

16. The system according to claim 15, further operable to provide a cardholder identity and a corresponding indicator of a presumed acquaintance to a 3^{rd} party system.

17. The system according to claim 1, further operable to provide a cardholder account number and a corresponding indicator of a presumed acquaintance to a card issuer computer system corresponding to said cardholder account number.

18. A method for analyzing payment card transaction data, comprising:
storing transaction information, said transaction information including, for each transaction: an identifier of a physical terminal at which said transaction was conducted, an indicator of a time at which said transaction was conducted, and an indicator of a cardholder account number to which said transaction is charged;
accessing said transaction information; and
analyzing said transaction information to compute from said transaction information an indicator of a presumed acquaintance between a first cardholder with a first account number and a second cardholder with another account number in response to said first and second cardholders conducting respective transactions within a period of time at a given terminal a plurality of times within a given interval, said interval being greater than said period of time.

19. The method according to claim 18, further comprising:
rewarding a cardholder according to a number of presumed acquaintances identified for the cardholder.

20. A computer readable non-transitory storage medium storing instructions of a computer program which when executed by a computer system results in performance of steps of:
storing transaction information, said transaction information including, for each transaction: an identifier of a physical terminal at which said transaction was conducted, an indicator of a time at which said transaction was conducted and an indicator of a cardholder account number to which said transaction is charged;
accessing said transaction information; and
analyzing the transaction information to compute from the transaction information an indicator of a presumed acquaintance between a first cardholder with a first account number and any further cardholder with another account number in response to said cardholders conducting respective transactions within a period of time at a given terminal a plurality of times within a given interval, said interval being greater than said period of time.
